(19) United States
(12) Patent Application Publication
(10) Pub. No.: US 2010/0173199 A1
(43) Pub. Date: Jul. 8, 2010

(54) SURFACE MODIFIED LITHIUM-CONTAINING COMPOSITE OXIDE FOR CATHODE ACTIVE MATERIAL FOR LITHIUN ION SECONDARY BATTERY AND ITS PRODUCTION PROCESS

(75) Inventors: Remi Hiraki, Chigasaki-shi (JP); Takeshi Kawasato, Chigasaki-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: AGC Seimi Chemical Co., Ltd., Chigasaki-shi (JP)

(21) Appl. No.: 12/683,458

(22) Filed: Jan. 7, 2010

Related U.S. Application Data
(63) Continuation of application No. PCT/JP09/61660, filed on Jun. 25, 2009.

(30) Foreign Application Priority Data
Jun. 26, 2008 (JP) 2008-167938

(51) Int. Cl. H01M 4/58; H01M 4/88; H01M 4/525; H01M 4/505

(52) U.S. Cl. 429/223; 429/231.95; 252/182.1; 429/224

(57) ABSTRACT

To provide a surface modified lithium-containing composite oxide for a cathode active material for a lithium ion secondary cell, which is excellent in volume capacity density, safety, durability for charge and discharge cycles and an excellent rate property, and its production process.

Particles of a lithium-containing composite oxide represented by the formula: LiₚNₓM_{y}O_{z}Fₐ, wherein N is at least one element selected from the group consisting of Co, Mn and Ni, M is at least one element selected from the group consisting of Al, Sn, alkaline earth metal elements and transition metal elements other than N, 0.9≦p≦1.3, 0.9≦x≦2.0, 0≦y≦0.1, 1.9≦z≦4.2, and 0≦a≦0.05, are impregnated with a solution containing a lanthanoid source and a titanium source, followed by heat treatment at from 550 to 1,000° C., to prepare a surface modified lithium-containing composite oxide having a highly crystalline lithium lanthanoid titanium composite oxide having a perovskite structure containing no fluorine contained in the surface layer of the particles.

### TECHNICAL FIELD

The present invention relates to a surface-modified lithium-containing composite oxide for a cathode active material for a lithium secondary battery, which has an excellent rate property, high safety, and excellent durability for charge and discharge cycles, its production process, a positive electrode for a lithium ion secondary battery containing the lithium-containing composite oxide, and a lithium ion secondary battery.

### BACKGROUND ART

Recently, as the portability and cordless tendency of instruments have progressed, a demand for a non-aqueous electrolytic solution secondary battery such as a lithium secondary battery which is small in size and light in weight and has a high energy density, has been increasingly high. As a cathode active material for the non-aqueous electrolyte secondary battery, a composite oxide of lithium and a transition metal or the like (which may be referred to as a “lithium-containing composite oxide” in some cases in the present invention) such as LiCoO₂, LiNi_{1/3}CO_{1/3}Mn_{1/3}O₂, LiNiO₂, LiNi_{0.8}Co_{0.2}O₂, LiMn₂O₄ or LiMnO₂, has been known.

Particularly, a lithium secondary battery using LiCoO₂ as a cathode active material and using a lithium alloy and carbon such as graphite or carbon fiber as a negative electrode, can obtain a high voltage at a level of 4 V, whereby it has been widely used as a battery having a high energy density.

However, in the case of the non-aqueous type secondary battery using LiCoO₂ as a cathode active material, further improvement has been desired e.g. in the discharge capacity, in the stability against heat during heating (which may be referred to as a “safety” in the present invention) and in the capacity density per unit volume of the positive electrode layer (which may be referred to as a “volume capacity density” in the present invention), and it had a problem of e.g. deterioration in the durability for charge and discharge cycles such as a decrease in the discharge capacity of the battery or swelling by a reaction of the cathode active material interface with the electrolytic solution.

In order to solve these problems, various studies have been made on surface treatment heretofore. For example, it has been proposed to prepare a surface modified lithium-containing composite oxide, by adding lithium hydroxide and titanium tetrachloride to an aqueous solution having a preliminarily synthesized lithium-containing composite oxide dispersed, followed by heat treatment, so that a lithium titanium composite oxide be present at the surface of particles (Patent Document 1).

Further, it has been proposed to mix a mixture of an electrically conductive agent and a lithium ion-conductive inorganic solid electrolyte, with a cathode active material such as LiCoO₂, followed by covering treatment by means of a planetary ball mill or mechanofusion, to prepare a cathode active material such as LiCoO₂ covered with a covering layer containing the electrically conductive agent and the lithium ion-conductive inorganic solid electrolyte (Patent Document 2).

Further, a cathode active material such as LiCoO₂ wherein the surface of particles is covered with an electrically conductive compound represented by Li₁₋ₓA_{y}BO₃₋ₓF_{z} (0≦x<1, 0≦y<1 and 0<z≦3), having a perovskite structure, containing Li and having free electrons, has been proposed (Patent Document 3).

Further, it has been proposed to use as a cathode active material a composite of Li₃ₓLa_{2/3-x}TiO₃ and LiCoO₂ obtained by filling a preliminarily prepared porous electrolyte Li_{0.35}La_{0.55}TiO₃ in which pores are connected with a sol of LiCoO₂, followed by gelation and firing in the air at 700° C. for one hour (Patent Document 4).

In addition, a cathode active material obtained by mixing a lithium manganese oxide (A) having a spinel structure and represented by the composition of Li_{1.04}Mn_{1.85}Al_{0.11}O₄ and a lanthanum titanium composite oxide (B) represented by the composition Li_{0.44}La_{0.52}□_{0.04}TiO₃ in a weight ratio of (A):(B)=9:1 has been proposed (Patent Document 5).

Patent Document 1: JP-A-2002-151078

Patent Document 2: JP-A-2003-059492

Patent Document 3: JP-A-2002-015776

Patent Document 4: JP-A-2006-260887

### DISCLOSURE OF THE INVENTION

### Object to be Accomplished by the Invention

However, despite the above described various studies, a lithium-containing composite oxide satisfying all of various characteristics such as the discharge capacity, the safety, the volume capacity density, and the durability for charge and discharge cycles has not yet been obtained.

For example, in Patent Document 1, lithium hydroxide and titanium tetrachloride are added to a liquid having a preliminarily synthesized lithium-containing composite oxide dispersed, followed by heat treatment to obtain a surface modified lithium-containing composite oxide, of which the surface of particles is covered with lithium titanate. However, if the compound covering the particle surface is lithium titanate, the capacity retention and the average voltage are relatively low, and the battery characteristics such as the durability for charge and discharge cycles are insufficient.

Further, the surface modified lithium-containing composite oxide as disclosed in Patent Document 2 is prepared by mixing a mixture of an electrically conductive agent and a lithium ion-conductive inorganic solid electrolyte, with a cathode active material such as LiCoO₂, followed by covering by means of a planetary ball mill or mechanofusion. Accordingly, a large amount of the electrically conductive agent and the lithium ion-conductive inorganic solid electrolyte are attached to the particle surface of the cathode active material, and the amount of the cathode active material which directly contributes to charge and discharge is reduced, and thus the discharge capacity is low. Further, as a covering method, a mechanical covering method such as a ball mill or mechanofusion is employed, and accordingly it is not possible to uniformly and thinly cover the particle surface with a small amount of the electrically conductive agent and a small amount of the lithium ion-conductive inorganic solid electrolyte. From such reasons, the surface modified lithium-containing composite oxide as disclosed in Patent Document 2 is insufficient in the rate property, the safety and the durability for charge and discharge cycles.

With respect to the surface modified lithium-containing composite oxide as disclosed in Patent Document 3, the particle surface is covered with Li₁₋ₓA_{y}BO₃₋ₓF_{z} (0≦x<1, 0≦y<1 and 0<z≦3), and the covering Li₁₋ₓA_{y}BO₃₋ₓF_{z} is low crystalline or amorphous and further contains fluorine, and thus it is a relatively unstable compound against heat and structural change caused by charge and discharge, and the capacity retention and the average voltage are very low, and the battery characteristics such as the durability for charge and discharge cycles are insufficient. Further, use of a nitrate as a production raw material for the surface modified lithium-containing composite oxide is essential, and accordingly, a noxious nitrous oxide gas is formed as a by-product at the time of the preparation.

Further, in Patent Document 4, a composite of Li₃ₓLa_{2/3-x}TiO₃ and LiCoO₂ is obtained by filling a preliminarily synthesized porous electrolyte Li_{0.35}La_{0.55}TiO₃ in which pores are connected with a sol of LiCoO₂, followed by gelation and firing in the air at 700° C. for one hour. However, in such a composite, the amount of the cathode active material which contributes to charge and discharge is reduced as compared with LiCoO₂ having the same volume, and accordingly, the discharge capacity is low. Further, the above composite is an assembly with an electrolyte, and the surface of the cathode active material particles is not covered, and accordingly the decomposition reaction of the electrolytic solution caused by charge and discharge cannot be suppressed, and battery characteristics such as the safety and the durability for charge and discharge cycles are insufficient.

Further, Patent Document 5 only discloses use of a mere mixture of a lithium manganese oxide (A) and a lanthanum titanium composite oxide (B) represented by the composition Li_{0.44}La_{0.52}□_{0.04}TiO₃ as a cathode active material. With a lithium-containing composite oxide obtained by such a covering method, similar to Patent Document 4, battery characteristics such as the safety and the durability for charge and discharge cycles are insufficient.

That is, methods which have been studied are to attempt to improve the safety, the durability for charge and discharge cycles and the rate property by a treatment to cover the particle surface with a predetermined compound or by a mixing treatment as described above. However, since the compound itself which exists on the surface layer of the particle surface does not contribute to charge and discharge, the discharge capacity is reduced, the rate property is deteriorated by inhibition of diffusion of lithium ions, or the decomposition reaction with the electrolytic solution can not sufficiently be suppressed and thus the safety is insufficient, and further improvements have been required.

Under these circumstances, it is an object of the present invention to provide a surface modified lithium-containing composite oxide which has large discharge capacity and volume capacity density, high safety, excellent durability for charge and discharge cycles and an excellent rate property, its production process, a positive electrode for a lithium ion secondary battery containing the surface modified lithium-containing composite oxide, and a lithium ion secondary battery.

### Means to Accomplish the Object

The present inventors have conducted extensive studies to accomplish the above object and as a result, accomplished the present invention which provides the following.
(1) A process for producing particles of a surface modified lithium-containing composite oxide comprising particles of a lithium-containing composite oxide represented by the formula: LiₚNₓM_{y}O_{z}Fₐ, wherein N is at least one element selected from the group consisting of Co, Mn and Ni, M is at least one element selected from the group consisting of Al, Sn, alkaline earth metal elements and transition metal elements other than Co, Mn and Ni, 0.9≦p≦1.3, 0.9≦x≦2.0, 0≦y≦0.1, 1.9≦z≦4.2, and 0≦a≦0.05, and a highly crystalline lithium lanthanoid titanium composite oxide having a perovskite structure containing no fluorine contained in the surface layer of the particles, which comprises impregnating the particles of the lithium-containing composite oxide with a solution containing a lanthanoid source and a titanium source, and subjecting the obtained impregnated particles to heat treatment at from 550 to 1,000° C.
(2) The process according to the above (1), wherein the solution containing a lanthanoid source and a titanium source has a pH of from 1 to 7.
(3) The process according to the above (1) or (2), wherein the solution containing a lanthanoid source and a titanium source contains a carboxylic acid having at least 2 carboxyl groups, or at least 2 in total of carboxyl groups and hydroxyl groups or carbonyl groups.
(4) The process according to any one of the above (1) to (3), wherein the titanium source is titanium lactate.
(5) The process according to any one of the above (1) to (4), wherein the solution containing a lanthanoid source and a titanium source is an aqueous solution.
(6) The process according to any one of the above (1) to (5), wherein the heat treatment temperature is from 650 to 900° C.
(7) The process according to any one of the above (1) to (6), wherein the solution containing a lanthanoid source and a titanium source contains a lithium source.
(8) The process according to the above (7), wherein the lithium source is lithium carbonate.
(9) The process according to any one of the above (1) to (8), wherein the lanthanoid source is at least one lanthanum compound selected from the group consisting of lanthanum acetate, lanthanum carbonate and lanthanum oxide.
(10) The process according to any one of the above (1) to (9), wherein when the particles of the lithium-containing composite oxide are impregnated with the solution containing a lanthanoid source and a titanium source, the solution is sprayed while the lithium-containing composite oxide is stirred.
(11) A surface modified lithium-containing composite oxide, comprising particles of a lithium-containing composite oxide represented by the formula: LiₚNₓM_{y}O_{z}Fₐ, wherein N is at least one element selected from the group consisting of Co, Mn and Ni, M is at least one element selected from the group consisting of Al, Sn, alkaline earth metal elements and transition metal elements other than Co, Mn and Ni, 0.9≦p≦1.3, 0.9≦x≦2.0, 0≦y≦0.1, 1.9≦z≦4.2, and 0≦a≦0.05, and a highly crystalline lithium lanthanoid titanium composite oxide having a perovskite structure containing no fluorine contained in the surface layer of the particles.
(12) The surface modified lithium-containing composite oxide according to the above (11), wherein the lithium lanthanoid titanium composite oxide is contained in a ratio of from 0.01 to 2 mol % as calculated as titanium based on the lithium-containing composite oxide.
(13) The surface modified lithium-containing composite oxide according to the above (11) or (12), wherein in an X-ray diffraction spectrum in which CuKa rays are used, a diffraction peak at 2θ=32.0±1.0° is shown, and the half value width of the diffraction peak is from 0.1 to 1.3°.
(14) The surface modified lithium-containing composite oxide according to any one of the above (11) to (13), wherein the lithium lanthanoid titanium composite oxide is a compound represented by the formula Li_{q}LnᵣTiO₃, wherein Ln is at least one element selected from the group consisting of La, Pr, Nd and Sm, 0≦q≦0.5, 0.1≦r<1, and 0.4≦q+r≦1.
(15) The surface modified lithium-containing composite oxide according to the above (14), wherein 0.01≦q≦0.5, and 0.1≦r≦0.95.
(16) The surface modified lithium-containing composite oxide according to any one of the above (11) to (15), wherein the M element contains at least one element selected from the group consistng of Al, Ti, Zr, Hf, Nb, Ta, Mg, Sn and Zn.
(17) A positive electrode for a lithium secondary battery, which comprises a cathode active material, an electroconductive material and a binder, wherein the cathode active material is the surface modified lithium-containing composite oxide as defined in any one of the above (11) to (16).
(18) A lithium ion secondary battery, which comprises a positive electrode, a negative electrode, an electrolytic solution and an electrolyte, wherein the positive electrode is the positive electrode as defined in the above (17).

### EFFECTS OF THE INVENTION

According to the present invention, it is possible to provide a surface modified lithium-containing composite oxide useful as a positive electrode for a lithium ion secondary battery, having large discharge capacity and volume capacity density, and excellent in the safety, the durability for charge and discharge cycles and the rate property, its production process, a positive electrode for a lithium ion secondary battery containing the surface modified lithium-containing composite oxide, and a lithium ion secondary battery.

The reason why the surface modified lithium-containing composite oxide according to the present invention demonstrates the above-mentioned excellent properties as the positive electrode for a lithium secondary battery, is not necessarily clear, but it is considered to be as follows.

With respect to the surface modified lithium-containing composite oxide of the present invention, on the surface layer of particles, a lithium lanthanoid titanium composite oxide is uniformly contained. The lithium lanthanoid titanium composite oxide of the present invention is stable against the structural change caused by charge and discharge, and can suppress breakdown of the crystal structure of the lithium-containing composite oxide caused by charge and discharge, even when a high electric current is applied. In addition, the surface layer in which the lithium lanthanoid titanium composite oxide is contained is very thin, and a highly crystalline lithium lanthanoid titanium composite oxide is uniformly contained at a high concentration in the thin surface layer. Accordingly, it is considered that the surface modified lithium-containing composite oxide of the present invention can suppress the reduction of the discharge capacity due to the presence of a compound other than the lithium-containing composite oxide in the surface layer to the maximum extent, and further, can remarkably improve the durability for charge and discharge cycles and the rate property. Further, since the lithium lanthanoid titanium composite oxide is a compound stable against heat, the surface modified lithium-containing composite oxide of the present invention also has high safety.

Further, the lithium lanthanoid titanium composite oxide according to the present invention is excellent in the lithium ion conductivity and the electrical conductivity, and the composite oxide itself can contribute to charge and discharge. Accordingly, by the surface layer containing the composite oxide, the discharge capacity can be increased, and the durability for charge and discharge cycles and the rate property can further be improved.

### BRIEF DESCRIPTION OF THE DRAWINGS

FIG. 1: X-ray diffraction spectrum of a surface modified lithium-containing composite oxide obtained in Example 1.

FIG. 2: X-ray diffraction spectra of powders obtained by heating a coating solution obtained in Example 1 at 400° C., 600° C., 700° C. and 800° C., respectively.

### BEST MODE FOR CARRYING OUT THE INVENTION

The surface modified lithium-containing composite oxide of the present invention comprises a lithium-containing composite oxide having a specific composition and having a surface layer which contains a highly crystalline lithium lanthanoid titanium composite oxide having a perovskite structure containing no fluorine. Further, the content of the lithium lanthanoid titanium composite oxide is preferably from 0.01 to 2 mol % as calculated as titanium based on the lithium-containing composite oxide as a base material. For example, when a lithium lanthanoid titanium composite oxide having a composition of Li_{0.35}La_{3.55}TiO₃ is present in the surface layer of 1 mol of a lithium-containing composite oxide as a base material, the molar ratio of Ti contained in the lithium lanthanoid titanium composite oxide Li_{0.35}La_{0.55}TiO₃ to the lithium-containing composite oxide is within a range of from 0.0001:1 to 0.02:1.

The amount of the lithium lanthanoid titanium composite oxide contained in the surface layer is preferably from 0.01 to 2 mol %, more preferably from 0.05 to 1 mol %, particularly preferably from 0.1 to 0.5 mol % as calculated as titanium based on the lithium-containing composite oxide as a base material.

Further, the lithium lanthanoid titanium composite oxide contained in the surface layer is a compound containing no fluorine. Here, “containing no fluorine” means that fluorine is not substantially contained, and it may be contained to a level of 100 ppm for example as an impurity. The lithium lanthanoid titanium composite oxide is more preferably a compound represented by the formula Li_{q}LnᵣTiO₃, wherein Ln is at least one element selected from the group consisting of La, Pr, Nd and Sm, 0<q≦0.5, 0.1≦r<1 and 0.4≦q+r≦1. Particularly, q is more preferably 0.01≦q≦0.5, furthermore preferably 0.1≦q≦0.45, particularly preferably 0.2≦q≦0.4. Further, r is more preferably 0.1≦r≦0.95, furthermore preferably 0.3≦r≦0.9, particularly preferably 0.4≦r≦0.8. Further, it is particularly preferred that 0.01≦q≦0.5 and that 0.1≦r≦0.95. Further, the total of q and r is not necessarily 1, and lattice defects may be present in the crystal structure of Li_{q}LnᵣTiO₃. Further, as a specifically preferred composition of the lithium lanthanoid titanium composite oxide, Li_{0.35}La_{0.55}TiO₃ is particularly preferred. In such a case, an obtainable positive electrode containing the lithium-containing composite oxide can suppress a reduction in the capacity density, and has improved charge and discharge efficiency, durability for charge and discharge cycles, rate property and safety. Here, if the lithium lanthanoid titanium composite oxide contains fluorine, the rate property and the durability for charge and discharge cycles will be remarkably deteriorated.

Further, the lithium lanthanoid titanium composite oxide according to the present invention has a perovskite structure as its crystal structure. In a diffraction spectrum of a lithium lanthanoid titanium composite oxide having a perovskite structure, generally, in an X-ray diffraction spectrum in which CuKa rays are used, diffraction peaks are confirmed at least at 2θ=32.0±1.0°, 46.5±1.0° and 58.0±1.0°, and the main peak is confirmed at 2θ=32.0±1.0°, as measured under conditions of an accelerating voltage of at least 40 kV and an electric current of at least 40 mA.

In the present invention, the highly crystalline lithium lanthanoid titanium composite oxide present in the surface layer of particles of the surface modified lithium-containing composite oxide may be a mixture of several types of lithium lanthanoid titanium composite oxides.

The surface modified lithium-containing composite oxide containing the lithium lanthanoid titanium composite oxide of the present invention is preferably such that in an X-ray diffraction spectrum in which CuKa rays are used, a diffraction peak is shown at 2θ=32.0±1.0°, and the half value width of the diffraction peak is preferably from 0.1 to 1.3°, more preferably from 0.1 to 1.2°, furthermore preferably from 0.1 to 1.0°, particularly preferably from 0.1 to 0.9°. The half value width within such a range is preferred in view of high crystallinity of the lithium lanthanoid titanium composite oxide contained, particularly battery characteristics such as the rate property and the durability for charge and discharge cycles. That is, when the half value width of the diffraction peak is from 0.1 to 1.3°, the composite oxide can be considered to be at least highly crystalline. On the other hand, an amorphous lithium lanthanoid titanium composite oxide showing no diffraction spectrum based on a lithium lanthanoid titanium composite oxide having a perovskite structure, or a low crystalline lithium lanthanoid titanium composite oxide with a half value width higher than 1.3, tend to be unfavorable in view of e.g. battery characteristics.

In a case where in the surface modified lithium-containing composite oxide of the present invention, the lithium lanthanoid titanium composite oxide is contained in a low ratio of 0.1 mol % for example as calculated as titanium based on the lithium-containing composite oxide, a diffraction peak by the lithium lanthanoid titanium composite oxide may not be detected in the X-ray diffraction spectrum even though the lithium lanthanoid titanium composite oxide is present. In such a case, a surface modified lithium-containing composite oxide having a lithium lanthanoid titanium composite oxide content increased to 1 mol % as calculated as titanium based on the lithium-containing composite oxide is prepared under the same production conditions, and its X-ray diffraction spectrum is measured, whereby a diffraction peak can be detected in the X-ray diffraction spectrum, and the half value width of the diffraction peak can be obtained.

The lithium-containing composite oxide used as a base material in the surface modified lithium-containing composite oxide of the present invention is obtained by a known method and is represented by the formula LiₚNₓM_{y}O_{z}Fₐ.

In the formula, p, x, y, z and “a” are as defined above. Particularly, p, x, y, z and “a” are respectively preferably as follows. 0.95≦p≦1.3, 0.9≦x≦1.0, 0≦y≦0.1, 1.9≦z≦2.1, and 0≦a≦0.05. Further, p, x, y, z and “a” are respectively particularly preferably as follows. 0.97≦p≦1.1, 0.97≦x≦1.00, 0.0005≦y≦0.05, 1.95≦z≦2.05 and 0.001≦a≦0.01.

In a case where the lithium-containing composite oxide as a base material contains no fluorine, the discharge capacity tends to be high as compared with a case where it contains fluorine, and it is preferred that a=0 when the capacity is important. Further, in a case where the lithium-containing composite oxide as a base material contains fluorine, a cathode active material wherein part of oxygen is substituted by fluorine is obtained, and the safety tends to be further improved, and accordingly when the safety is important, fluorine is preferably contained so that “a” is within the above range.

In the above formula, element N is at least one element selected from the group consisting of Co, Mn and Ni. Particularly, element N is preferably Co alone, Ni alone, a combination of Co and Ni, a combination of Mn and Ni or a combination of Co, Ni and Mn, more preferably Co alone or a combination of Co, Ni and Mn, particularly preferably Co alone.

In the present invention, element M is at least one element selected from the group consisting of Al, Sn alkaline earth metal elements and transition metal elements other than Co, Mn and Ni. Here, the above transition metal elements represent transition metals of Group 4, Group 5, Group 6, Group 7, Group 8, Group 9, Group 10, Group 11 or Group 12 in the Periodic Table. Particularly, element M is preferably at least one element selected from the group consisting of Al, Ti, Zr, Hf, Nb, Ta, Mg, Sn and Zn. From the viewpoint of the discharge capacity, the safety, the durability for charge and discharge cycles, etc., element M is more preferably at least one element selected from the group consisting of Al, Ti, Zr, Nb and Mg.

When element M contains Al and Mg, the atomic ratio of Al to Mg is preferably from 1/4 to 4/1, particularly preferably from 1/3 to 3/1, and further when y is preferably 0.005≦y≦0.05, particularly preferably 0.01≦y≦0.035, the balance of battery performance i.e. the balance of the discharge capacity, the safety and the durability for charge and discharge cycles, is good.

When element M contains Zr and Mg, the atomic ratio of Zr to Mg is preferably from 1/40 to 2/1, particularly preferably from 1/30 to 1/5, and further when y is preferably 0.005≦y≦0.05, particularly preferably 0.01≦y≦0.035, the balance of battery performance i.e. the balance of the discharge capacity, the safety and the durability for charge and discharge cycles, is good.

In the present invention, the molar ratio Li/(N+M) which is a value obtained by dividing the molar amount of lithium in the lithium-containing composite oxide by the total amount of element N and element M is particularly preferably from 0.97 to 1.10. It is more preferably from 0.99 to 1.05, and in such a case, the particle growth of the lithium-containing composite oxide by firing will be accelerated, and particles with a higher density can be obtained.

In the surface modified lithium-containing composite oxide of the present invention, it is preferred that the lithium lanthanoid titanium composite oxide exists in the surface layer of particles at a higher concentration than the inside of the particles. It is considered that by the lithium lanthanoid titanium composite oxide existing in the surface layer on the particle surface, the contact area between the lithium-containing composite oxide and an electrolytic solution can be decreased, and resultingly, the safety is improved, and the durability for charge and discharge cycles is improved. Here, the surface area of particles of the lithium-containing composite oxide means a part from the surface of the primary particles to preferably 100 nm from the surface of the particles.

With respect to the surface modified lithium-containing composite oxide of the present invention, the average particle size D50 is preferably from 5 to 30 μm, particularly preferably from 8 to 25 μm, the specific surface area is preferably from 0.1 to 0.7 m²/g, particularly preferably from 0.15 to 0.5 m²/g, the half value width of the diffraction peak of (110) plane at 2θ=66.5±1° as measured by means of an X-ray diffraction in which CuKa rays are used as a radiation source, is preferably from 0.08 to 0.14°, particularly preferably from 0.08 to 0.12°.

Here, the average particle size D50 in the present invention means a volume-based accumulative 50% size (D50) which is a particle size at a point of 50% on an accumulative curve when the accumulative curve is drawn so that a particle size distribution is obtained on the volume basis and the whole volume is 100%. The particle size distribution is obtained from a frequency distribution and accumulative volume distribution curve measured by means of a laser scattering particle size distribution measuring apparatus. The measurement of particle sizes is carried out by measuring the particle size distribution while the powder is sufficiently dispersed in an aqueous medium by an ultrasonic treatment or the like (for example, using Microtrack HRAX-100 manufactured by NIKKISO CO., LTD.). Furthermore, D10 means a volume-based accumulative 10% size, and D90 means a volume-based accumulative 90% size.

Further, with respect to the surface modified lithium-containing composite oxide obtained in the present invention, the average particle size D50 means a volume-averaged particle size of secondary particles which are formed by mutual agglomeration and sintering of primary particles, and in a case where the particles are composed of the primary particles only, it means a volume-averaged particle size of the primary particles.

Further, when element N is cobalt, the press density of the surface modified lithium-containing composite oxide obtained by the present invention is preferably from 2.7 to 3.4 g/cm³, more preferably from 2.8 to 3.3 g/cm³, particularly preferably from 2.9 to 3.3 g/cm³ In the present invention, the press density means an apparent density of the powder of the surface modified lithium-containing composite oxide when the powder is pressed under a pressure of 0.3 ton/cm². Further, in the surface modified lithium-containing composite oxide of the present invention, the amount of free alkali is preferably at most 0.035% by weight, particularly preferably at most 0.02% by weight.

With respect to the surface modified lithium-containing composite oxide of the present invention, since the lithium lanthanoid titanium composite oxide is present in the surface layer of particles, the contact area between the lithium-containing composite oxide and an electrolytic solution can be reduced, and elution of atoms of e.g. cobalt to the electrolytic solution at the time of charge and discharge can be suppressed. This can be quantitatively evaluated by measuring the free alkali amount which represents the amount of alkali eluted from the lithium-containing composite oxide. This value of the free alkali amount indicates excellent safety and durability for charge and discharge cycles of the surface modified lithium-containing composite oxide of the present invention. In the present invention, the free alkali amount will sometimes be referred to simply as the alkali amount.

As the process for producing the surface modified lithium-containing composite oxide of the present invention, a powder of a preliminarily prepared lithium-containing composite oxide is impregnated with a solution containing at least a lanthanoid source and a titanium source (sometimes referred to as a coating solution in the present invention), and the obtained lithium lanthanoid titanium-impregnated particles are subjected to heat treatment to prepare the surface modified lithium-containing composite oxide. From the viewpoint of the influence over environment and the cost, the coating solution is preferably an aqueous solution, and it is more preferred that the solvent is water. Here, the aqueous solution means a solution using as a solvent an aqueous medium, i.e. a solvent containing water as the main component and containing water, an alcohol, ethylene glycol, glycerol or the like. Particularly preferred is a solution containing water in an amount of from 80 to 100% by weight.

It is considered that by the use of the above production process, in a case where the particle surface is coated to prepare surface modified lithium-containing composite oxide particles, the surface of primary particles forming secondary agglomerated particles can be covered, and the surface of the primary particles can be uniformly covered as compared with a conventional solid phase reaction or dispersed particles-containing solution, and therefore, characteristics of a battery which uses the obtained surface modified lithium-containing composite oxide are improved.

The coating solution used in the present invention contains at least a lanthanoid source and a titanium source, and preferably further contains a lithium source. The coating solution may be either a suspension or a colloidal solution. However, in order to cover the particle surface more uniformly with a small amount of the compound, preferred is a coating solution in which such compounds are dissolved, and specifically, it is preferred that the lithium source, the lanthanoid source, the titanium source and the like are dissolved so as not to be visually identified at least as solid components. In such a case, the composition of the lithium lanthanoid titanium composite oxide can easily be controlled. Further, in a case where the coating solution contains no lithium source, lithium atoms are withdrawn from the lithium-containing composite oxide as a base material at the time of heat treatment, and reacted with the lanthanoid source and the titanium source to form a lithium lanthanoid titanium composite oxide.

In the present invention, the coating solution preferably contains a carboxylic acid. The carboxylic acid may be in the form of a salt of a compound. The carboxylic acid is preferably a carboxylic acid having at least 2 carboxyl groups or at least 2 in total of carboxyl groups and hydroxyl groups or carbonyl groups. Such a carboxylic acid is preferably used, since it can improve the solubility of the lithium source, the lanthanoid source and the titanium source and raise the concentration of lithium ions, lanthanoid ions and titanium ions dissolved in the aqueous solution. Particularly preferred is a case where it has a molecular structure wherein from 2 to 4 carboxyl groups exist and further from 1 to 4 hydroxyl groups coexist, since the solubility can thereby be made high. The carboxylic acid is particularly preferably an aliphatic carboxylic acid having from 2 to 8 carbon atoms, particularly preferably from 2 to 6 carbon atoms. When the number of carbon atoms is from 2 to 8, the solubility of the lithium source, the lanthanoid source and the titanium source will be improved, and the number of carbon atoms is particularly preferably from 2 to 6.

The aliphatic carboxylic acid having from 2 to 8 carbon atoms is preferably citric acid, tartaric acid, oxalic acid, malonic acid, maleic acid, malic acid, racemic acid, lactic acid or glyoxylic acid, particularly preferably citric acid, maleic acid, lactic acid or tartaric acid, since it is possible to raise the solubility and the cost is relatively low. When a carboxylic acid with a high acidity is used, the lithium-containing composite oxide as a base material tends to be dissolved when the pH of the coating solution is lower than 1. In such a case, it is preferred to adjust the pH in a range of from 1 to 7, more preferably from 1 to 6 by addition of a base such as ammonia.

Further, it is possible to adjust the pH of the coating solution by adding a pH adjuster and/or an aqueous alkaline solution to the coating solution. The pH adjuster to be used may be ammonia, ammonium bicarbonate or the like. The aqueous alkaline solution to be used may be a solution of e.g. a hydroxide such as sodium hydroxide, potassium hydroxide or lithium hydroxide.

The lithium source, the lanthanoid source and the titanium source to be used for preparation of the coating solution are preferably the ones dissolved uniformly in the solution. For example, preferred is an inorganic salt such as an oxide, a hydroxide or a carbonate, an organic acid salt such as an acetate, an oxalate, a citrate or a lactate, an organic metal chelate complex, or a compound wherein a metal alkoxide is stabilized by e.g chelate. Among them, more preferred is the oxide, the hydroxide, the carbonate, the nitrate, the acetate, the oxalate, the citrate or the lactate.

The coating solution to be used in the present invention can be prepared with heating, if necessary. Preferred is to heat at from 40° C. to 80° C., particularly preferably at from 50° C. to 70° C. The heating makes the dissolution of the lithium source, the lanthanoid source and the titanium source proceed easily, whereby the lithium source, the lanthanoid source and the titanium can be stably dissolved in a short period of time.

In the present invention, the higher the total concentration of the lithium source, the lanthanoid source and the titanium source contained in the coating solution to be used in the present invention, the better, since it is desired that the aqueous medium is in a small amount in the subsequent step of heat treatment. However, if the concentration is too high, the viscosity will become high to deteriorate the mixing property with the lithium source, the lanthanoid source and the titanium source, and whereby it will be difficult to coat the surface of particles of the lithium-containing composite oxide uniformly with the lithium lanthanoid titanium composite oxide. Therefore, the concentration is preferably from 0.01 to 30% by weight, more preferably from 0.1 to 15% by weight.

The above coating solution may contain an alcohol such as methanol or ethanol, or a polyol having an effect to let a complex form. Examples of the polyol include ethylene glycol, propylene glycol, diethylene glycol, dipropylene glycol, polyethylene glycol and butane diol glycerin. When these compounds are contained, the content is preferably from 1 to 20% by weight.

Further, as the titanium source in the coating solution of the present invention, titanium lactate is preferred. Titanium lactate has carboxyl groups and hydroxyl groups in the molecule, whereby the chelate effect stabilizes lithium ions, lanthanoid ions and titanium ions contained in the coating solution.

Further, as the lithium source in the coating solution of the present invention, it is preferred to use lithium carbonate or lithium hydroxide, and more preferred is lithium carbonate available at a lower cost among them. The average particle size D50 of the lithium source is preferably from 2 to 25 μm, whereby it is easily dissolved.

Further, the lanthanoid source in the coating solution according to the present invention is preferably at least one member selected from the group consisting of an acetate, a carbonate and an oxide of lanthanoid. Particularly when lanthanoid element is lanthanum, it is preferred to use at least one member selected from the group consisting of lanthanum acetate, lanthanum carbonate and lanthanum oxide, and more preferred is lanthanum acetate which is easily dissolved and is available at a low cost.

The method of impregnating the lithium-containing composite oxide with the coating solution is not limited, but may be a means for impregnation by spraying the coating solution to the powder of the lithium-containing composite oxide, or a means for impregnation by mixing and stirring the coating solution and the lithium-containing composite oxide in a container. Specific examples of the spraying means include a spray drier, a flash drier, a belt drier, a lodige mixer, a thermoprocessor or a paddle dryer. The means of mixing and stirring in a container to be used may, for example, be a twin screw kneader, an axial mixer, a paddle mixer, a turbulizer, a lodige mixer or a drum mixer. Particularly, as a method of impregnating the lithium-containing composite oxide with the coating solution, it is preferred to spray the coating solution while a powder of the lithium-containing composite oxide is stirred for impregnation, and specifically, it is more preferred to use a lodige mixer. By use of a lodige mixer, the coating solution can be sprayed with uniform stirring. By spraying the coating solution while the powder of the lithium-containing composite oxide is uniformly stirred for impregnation, uniform covering is possible, and the battery characteristics tend to be further improved. Further, heat may be applied at the time of impregnation, whereby drying is carried out simultaneously. Further, in this case, a solid content concentration in the slurry is preferably as high as possible as long as the mixture is uniformly mixed, and a solid/liquid ratio (based on weight) is preferably from 30/70 to 99.5/0.5, more preferably from 85/15 to 99/1, particularly preferably from 90/10 to 97/3. Further, it is preferred to perform reduced pressure treatment while carrying out impregnation, since it is thereby possible to simultaneously dry the lithium-containing composite oxide impregnated with the coating solution in a short time.

After impregnating the powder of the lithium-containing composite oxide of the present invention with the coating solution, the obtained impregnated particles can be dried. In this case, the impregnated particles are dried preferably at from 15 to 200° C., particularly preferably at from 50 to 120° C., usually, for from 0.1 to 10 hours. Since the aqueous medium in the impregnated particles will be removed in a subsequent step of heat treatment, it is not necessary to remove it completely at this stage. However, it is preferred to remove it as much as possible at this stage, since a lot of energy will be required to volatilize moisture in a subsequent step of heat treatment.

Further, the temperature during heat treatment of the lithium-containing composite oxide particles impregnation with the coating solution of the present invention is from 550 to 1,000° C., preferably from 650 to 900° C., more preferably from 750 to 850° C. When heat treatment is carried out within such a temperature range, it is possible to obtain a surface modified lithium-containing composite oxide having a highly crystalline lithium lanthanoid titanium composite oxide having a perovskite structure formed in the surface layer of the lithium-containing composite oxide particles, and having further improved battery characteristic such as the discharge capacity, the durability for charge and discharge cycles and the safety. The preferred range of the heat treatment temperature may vary depending on the type of the salt as a material, i.e. either a nitrate, a sulfate or a carbonate. Further, the heat treatment is preferably carried out in an oxygen-containing atmosphere, specifically, more preferably in an atmosphere at an oxygen concentration of from 10 to 40 vol %. If the heat treatment temperature is less than 550° C., the crystallinity tends to be poor, and for example, if it is 400° C., the lithium lanthanoid titanium composite oxide will be amorphous. The heat treatment time is preferably at least 30 minutes, more preferably at least 1 hour, furthermore preferably at least 3 hours, and it is preferably at most 120 hours, more preferably at most 60 hours, furthermore preferably at most 30 hours.

In a case where a positive electrode for a lithium secondary battery is to be produced from such a surface modified lithium-containing composite oxide, the powder of the composite oxide is mixed with a carbon type electroconductive material such as acetylene black, graphite or Ketjenblack and a binder material. As the above binder material, polyvinylidene fluoride, polytetrafluoroethylene, polyamide, carboxymethyl cellulose or an acrylic resin may, for example, be preferably employed. The powder of the surface modified lithium-containing composite oxide of the present invention, the electroconductive material and the binder material will be formed into a slurry or a kneaded product by using a solvent or a dispersion medium. The resultant is supported on a positive electrode current collector such as an aluminum foil or a stainless steel foil by e.g. coating to form a positive electrode for a lithium secondary battery.

In the lithium secondary battery using the surface modified lithium-containing composite oxide of the present invention as the cathode active material, a film of a porous polyethylene or a porous polypropylene may, for example, be used as a separator. Furthermore, as the solvent for the electrolytic solution of a battery, various solvents may be used, and a carbonate ester is preferred. As the carbonate ester, each of a cyclic type and a chain type can be used. As the cyclic carbonate ester, propylene carbonate or ethylene carbonate (EC) may, for example, be mentioned. As the chain carbonate ester, dimethyl carbonate, diethyl carbonate (DEC), ethyl methyl carbonate (EMC), methyl propyl carbonate or methyl isopropyl carbonate may, for example, be mentioned.

In the present invention, the above carbonate ester may be used alone or two or more of them may be used as mixed. Moreover, it may be used as mixed with another solvent. Furthermore, depending upon the material of the anode active material, there may be a case where the discharge property, the durability for charge and discharge cycles, or charge and discharge efficiency can be improved by a combined use of a chain carbonate ester and a cyclic carbonate ester.

Further, in the lithium secondary battery using the surface modified lithium-containing composite oxide of the present invention as the cathode active material, a gel polymer electrolyte containing a vinylidene fluoride-hexafluoropropylene copolymer (for example, KYNAR manufactured by ELF Atochem) or a vinylidene fluoride-perfluoropropyl vinyl ether copolymer may be employed. As the solute to be added to the electrolytic solvent or the polymer electrolyte, at least one member of lithium salts is preferably used, wherein e.g. ClO₄⁻, CF₃SO₃⁻, BF₄⁻, PF₆⁻, AsF₆⁻, SbF₆⁻, CF₃CO₂⁻ or (CF₃SO₂)₂N⁻ is anion. The lithium salt is preferably added in a concentration of from 0.2 to 2.0 mol/l (liter) to the electrolytic solvent or the polymer electrolyte comprising the lithium salt. If the concentration departs from this range, ionic conductivity will decrease, and the electrical conductivity of the electrolyte will decrease. The concentration is particularly preferably from 0.5 to 1.5 mol/l.

In the lithium battery using the surface modified lithium-containing composite oxide of the present invention as the cathode active material, a material which can occlude and discharge lithium ions may be used for the anode active material. The material forming the anode active material is not particularly limited, however, lithium metal, a lithium alloy, a carbon material, a carbon compound, a silicon carbide compound, a silicon oxide compound, titanium sulfide, a boron carbide compound or an oxide comprising, as a main component, a metal of Group 14 or Group 15 in the Periodic Table, may, for example, be mentioned. As the carbon material, one having an organic material thermally decomposed under various thermal decomposition conditions, artificial graphite, natural graphite, soil graphite, exfoliated graphite or flake graphite may, for example, be used. Further, as the oxide, a compound comprising tin oxide as a main component can be used. As the anode current collector, a copper foil or a nickel foil may, for example, be used. The negative electrode is produced preferably by kneading the anode active material with an organic solvent to form a slurry, which is applied to the metal foil current collector, dried and pressed.

There are no particular restrictions on the shape of the lithium battery using the lithium-containing composite oxide of the present invention as the cathode active material. The shape is selected from a sheet shape, a film shape, a folded shape, a wound cylinder with bottom, a button shape and so on, depending upon the intended purpose.

### EXAMPLES

Now, the present invention will be described in further detail with reference to Examples. However, the present invention is by no means restricted to such specific Examples.

### Example 1

In an aqueous solution having 1.93 g of magnesium carbonate, 20.89 g of aluminum maleate having an Al content of 2.65% by weight and 7.76 g of citric acid monohydrate dissolved in 23.12 g of water, an aqueous solution obtained by mixing 1.29 g of a zirconium ammonium carbonate aqueous solution having a zirconium content of 14.5% by weight and 197.32 g of cobalt oxyhydroxide with an average particle size of 13 μm and a cobalt content of 60.0% by weight were added and mixed. The resultant mixture was dried in a constant-temperature oven kept at 80° C., and the dried mixture was mixed with 77.69 g of lithium carbonate having a lithium content of 18.7% by weight in a mortar, and fired at 990° C. for 14 hours in an oxygen-containing atmosphere, followed by crushing to obtain a powder of a lithium-containing composite oxide having a composition of Li_{1.01}(Co_{0.979}Mg_{0.01}Al_{0.01}Zr_{0.001})_{0.99}O₂.

To 200 g of the above powder of the lithium-containing composite oxide, a coating solution having a pH of 4.0, having 11.98 g of a titanium lactate aqueous solution having a Ti content of 8.20% by weight, 0.23 g of lithium carbonate having a lithium content of 18.7% by weight and 4.22 g of lanthanum oxide dissolved in 53.56 g of water, was added, followed by drying at 120° C. for 4 hours with mixing and stirring to obtain lithium lanthanoid titanium-impregnated particles. Further, the obtained lithium lanthanoid titanium-impregnated particles were subjected to heat treatment at 700° C. for 12 hours in an oxygen-containing atmosphere, followed by crushing to obtain a powder of a surface modified lithium-containing composite oxide having an average particle size D50 of 15.8 μm, D10 of 9.4 μm, D90 of 24.7 μm and a specific surface area of 0.34 m²/g obtained by the BET method. The press density of the powder was 2.92 g/cm³. The alkali amount of the obtained surface modified lithium-containing composite oxide was 0.007% by weight.

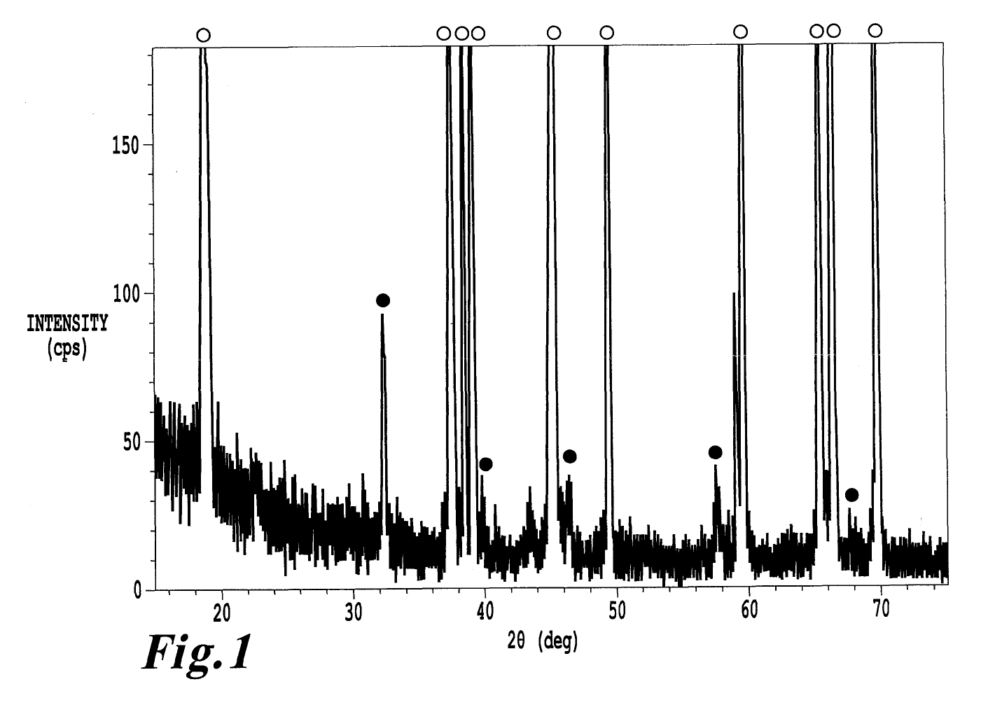

Further, an X-ray diffraction spectrum of the obtained surface modified lithium-containing composite oxide was measured by using RINT 2100 model manufactured by Rigaku Corporation using CuKa rays under an accelerating voltage of 40 KV at an electric current of 40 mA with a scanning range of from 15 to 75° with a sampling width of 0.020 at a scanning speed of 2.000°/min with a divergence slit of 1° with a divergence longitudinal slit of 10 mm with a scattering slit of 1° with a receiving slit of 0.15 mm. In a spectrum chart (FIG. 1) obtained by this measurement, in addition to peaks derived from a lithium-containing composite oxide, peaks derived from a lithium lanthanoid titanium composite oxide having a perovskite structure were confirmed at 2θ=32.0±1.0°, 40.0±1.0°, 46.5±1.0°, 58.0±1.0° and 68.0±1.0°. In FIG. 1, peaks with outlined circles are peaks derived from a lithium-containing composite oxide having a composition of Li_{1.01}(Co^{0.979}Mg_{0.01}Al^{0.01}Zr_{0.001})_{0.99}O₂, and peaks with black circles are peaks derived from the lithium lanthanoid titanium composite oxide according to the present invention. This diffraction spectrum substantially agrees with the normal spectrum of Li_{0.35}La_{0.55}TiO₃ having a perovskite crystal structure, and the obtained composite oxide was found to be a lithium lanthanoid titanium composite oxide having a perovskite crystal structure having a chemical composition which substantially agrees with Li_{0.35}La_{0.55}TiO₃.

With respect to the obtained X-ray diffraction spectrum, smoothing and background treatment were carried out, and the angle was corrected by the external standard Si, whereby the half value width of the peak at 2θ=32.0±1.0° was obtained and as a result, it was 0.794°.

Further, in a powder X-ray diffraction in which CuKa rays were used of the powder of the surface modified lithium-containing composite oxide, the half value width of (110) plane at 2θ=66.5±1.0° was 0.111°.

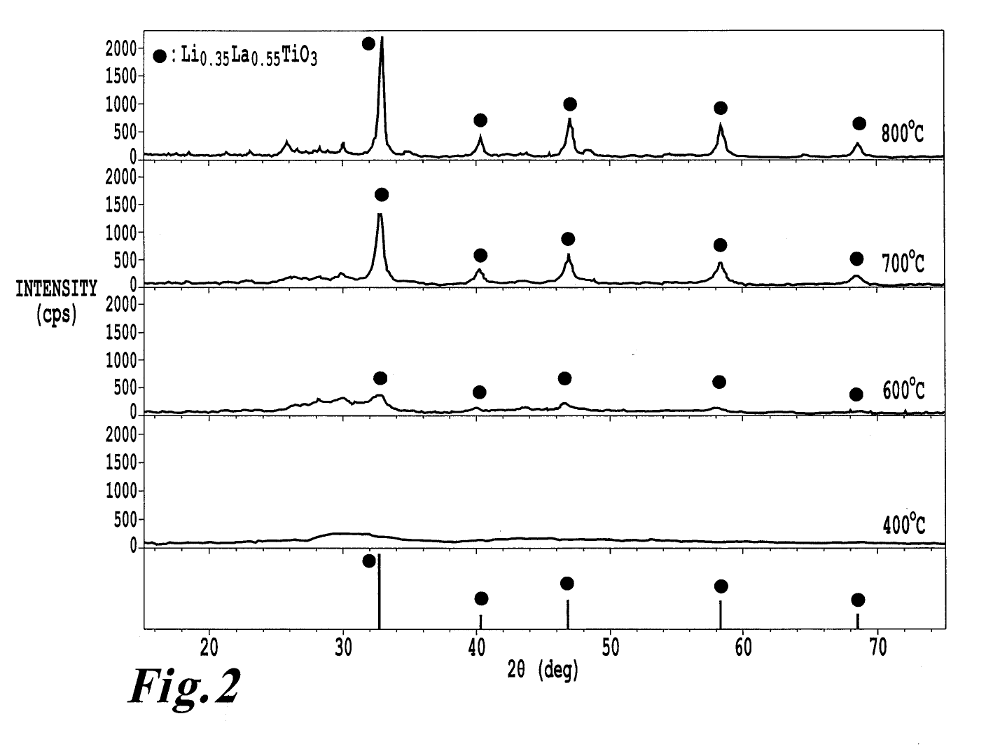

Further, separately, X-ray diffraction spectra of powders obtained by heating the above coating solution at 400° C., 600° C., 700° C. and 800° C., respectively, were measured, and the obtained spectral charts are shown in FIG. 2. It is found from FIG. 2 that crystals sufficiently grow when the firing temperature are increased to 600° C., 700° C. and 800° C., but crystal growth of the powder fired at 400° C. was insufficient, and it was amorphous.

The above powder of the surface modified lithium-containing composite oxide, acetylene black and a polyvinylidene fluoride powder were mixed at a weight ratio of 90/5/5, and N-methylpyrrolidone was added to form a slurry, which was applied onto one side of an aluminum foil having a thickness of 20 μm, by a doctor blade. After drying, roll pressing was carried out five times to obtain a positive electrode sheet for a lithium battery.

Then, three simplified sealed cell type lithium batteries of stainless steel were assembled in an argon glove box, using a punched sheet from the positive electrode sheet as a positive electrode, a metal lithium foil having a thickness of 500 μm as a negative electrode, a nickel oil of 20 μm as a negative electrode current collector, a porous polypropylene having a thickness of 25 μm as a separator and an LiPF₆/EC+DEC (1:1) solution (which means a mixed solution of EC and DEC in a volume ratio (1:1) whose solute is LiPF₆; the same also applies to solvents as mentioned hereinafter) in a concentration of 1 M as an electrolytic solution.

One battery out of the above three was charged up to 4.3 V at a load current of 75 mA per 1 g of the cathode active material at 25° C., and discharged down to 2.5 V at a load current of 75 mA per 1 g of the cathode active material, thereby obtaining a discharge capacity per 1 g of the cathode active material (hereinafter sometimes referred to as 4.3 V initial discharge capacity). Then, the battery was discharged down to 2.5 V at a high load current of 225 mA per 1 g of the cathode active material, thereby obtaining the discharge capacity (hereinafter sometimes referred to as high rate capacity retention) and the average electric potential during discharge (hereinafter sometimes referred to as a high rate average electric potential). As a result, the 4.3 V initial discharge capacity was 152 mAh/g, the high rate capacity retention was 93.5%, and the high rate average electric potential was 3.87 V.

Further, one battery out of the above three was charged up to 4.5 V at a load current of 75 mA per 1 g of the cathode active material at 25° C. and discharged down to 2.5 V at a load current of 75 mA per 1 g of the cathode active material, thereby obtaining an initial discharge capacity (hereinafter sometimes referred to as 4.5 V initial discharge capacity), and with this battery, the charge and discharge cycle test was sequentially carried out 50 times. As a result, the 4.5 V initial discharge capacity was 183 mAh/g, the initial charge and discharge efficiency was 93.1, the initial average electrical potential during discharge was 4.02 V, the capacity retention after 50 charge and discharge cycles was 94.1%, and the average electric potential during discharge was 3.98 V (hereinafter they will sometimes be referred to as 4.5 V initial charge and discharge efficiency, 4.5 V initial average electric potential, 4.5 V capacity retention and 4.5 V average electric potential, respectively).

Moreover, the other battery was charged at 4.3 V for 10 hours, then disassembled in the argon glove box. The positive electrode sheet after charged was taken out, washed, punched into a diameter of 3 mm, and then sealed with EC in an aluminum capsule. Then, while the temperature was raised at a rate of 5° C./min by a scanning differential calorimeter, the heat generation starting temperature was measured. As a result, the heat generation starting temperature of a heat generation curve of the 4.3 V-charged product was 160° C.

### Example 2

A surface modified lithium-containing composite oxide was prepared in the same manner as in Example 1 except that the heat treatment temperature for the lithium lanthanoid titanium-impregnated particles was changed from 700° C. to 600° C. Of the surface modified lithium-containing composite oxide, the average particle size D50 was 14.2 μm, D10 was 8.0 μm, D90 was 23.2 μm, and the specific surface area as obtained by the BET method was 0.46 m²/g. Further, of the obtained powder of the surface modified lithium-containing composite oxide, the alkali amount was 0.011% by weight, and the press density was 2.90 g/cm³.

With respect to the powder of the surface modified lithium lanthanoid titanium composite oxide, an X-ray diffraction spectrum was measured in the same manner as in Example 1, whereupon peaks derived from a lithium-containing composite oxide and a lithium lanthanoid titanium composite oxide having a perovskite crystal structure were confirmed. Further, the half value width of the peak at 2θ=32.0±1.0° was obtained and as a result, it was 1.141°. The half value width of the diffraction peak of (110) plane at 2θ=66.5±1° was 0.108°.

With respect to the above surface modified lithium-containing composite oxide, electrodes and batteries were prepared and evaluated in the same manner as in Example 1. As a result, the 4.3 V initial discharge capacity was 151 mAh/g, the high rate capacity retention was 92.9%, and the high rate average electric potential was 3.88 V.

Further, the 4.5 V initial discharge capacity was 180 mAh/g, the 4.5 V initial charge and discharge efficiency was 91.9%, the 4.5 V initial average electric potential was 4.03 V, the 4.5 V capacity retention was 80.6%, and the 4.5 V average electric potential was 3.86 V. Further, the heat generation starting temperature was 162° C.

### Example 3

A surface modified lithium-containing composite oxide was prepared in the same manner as in Example 1 except that the heat treatment temperature for the lithium lanthanoid titanium-impregnated particles was changed from 700° C. to 800° C. Of the surface modified lithium-containing composite oxide, the average particle size D50 was 14.7 μm, D10 was 8.3 μm, D90 was 24.4 μm, and the specific surface area as obtained by the BET method was 0.28 m²/g. Further, of the powder of the surface modified lithium-containing composite oxide, the alkali amount was 0.005% by weight.

With respect to the powder of the surface modified lithium-containing composite oxide, an X-ray diffraction spectrum was measured in the same manner as in Example 1. As a result, peaks derived from a lithium-containing composite oxide and a lithium lanthanoid titanium composite oxide having a perovskite crystal structure were confirmed. Further, the half value width of the peak at 2θ0=32.0±1.0° was obtained and as a result, it was 0.250°. The half value width of the diffraction peak of (110) plane at 2θ=66.5±1° was 0.106°. The press density of the powder was 2.94 g/cm³.

With respect to the above surface modified lithium-containing composite oxide, electrodes and batteries were prepared and evaluated in the same manner as in Example 1. As a result, the 4.3 V initial discharge capacity was 151 mAh/g, the high rate capacity retention was 94.4%, and the high rate average electric potential was 3.88 V.

Further, the 4.5 V initial discharge capacity was 181 mAh/g, the 4.5 V initial charge and discharge efficiency was 92.9%, the 4.5 V initial average electric potential was 4.03 V, the 4.5 V capacity retention was 96.6%, and the 4.5 V average electric potential was 3.98 V. Further, the heat generation starting temperature was 169° C.

### Example 4

A surface modified lithium-containing composite oxide was prepared in the same manner as in Example 1 except that to 200 g of the powder of the lithium-containing composite oxide, an aqueous solution having a pH of 4.0 and having 1.20 g of a titanium lactate aqueous solution having a Ti content of 8.20% by weight, 0.02 g of lithium carbonate having a lithium content of 18.7% by weight and 0.42 g of lanthanum acetate dissolved in 68.36 g of water was used as the coating solution, in a coating amount based on a base material of 0.1 mol % as calculated as titanium. Of the surface modified lithium-containing composite oxide, the average particle size D50 was 12.6 μm, D10 was 7.6 μm, D90 was 19.4 μm, and the specific surface area as obtained by the BET method was 0.24 m²/g. Of the obtained powder of the surface modified lithium-containing composite oxide, the alkali amount was 0.008% by weight.

With respect to the powder of a surface modified lithium-containing composite oxide, the X-ray diffraction spectrum was measured in the same manner as in Example 1, whereupon the half value width of the diffraction peak of (110) plane at 2θ=66.5±1° was 0.103°. Further, the press density of the powder was 2.99 g/cm³. Further, in FIG. 2 illustrating an X-ray diffraction spectrum of a powder obtained by subjecting the coating solution to heat treatment at 700° C., peaks derived from Li_{0.35}La_{0.55}TiO₃ having a perovskite crystal structure are confirmed. Further, in Example 1 wherein the coating amount was 1 mol % as calculated as titanium, a highly crystalline lithium lanthanoid titanium composite oxide is confirmed. Accordingly, it is judged that in the surface layer of the obtained surface modified lithium-containing composite oxide, a highly crystalline lithium lanthanoid titanium composite oxide having a perovskite crystal structure is contained in the same manner.

With respect to the above surface modified lithium-containing composite oxide, electrodes and batteries were prepared and evaluated in the same manner as in Example 1. As a result, the 4.3 V initial discharge capacity was 152 mAh/g, the high rate capacity retention was 94.5%, and the high rate average electric potential was 3.89 V.

Further, the 4.5 V initial discharge capacity was 180 mAh/g, the 4.5 V initial charge and discharge efficiency was 92.1%, the 4.5 V initial average electric potential was 4.03 V, the 4.5 V capacity retention was 88.4%, and the 4.5 V average electric potential was 3.88 V. Further, the heat generation starting temperature was 163° C.

### Example 5

A surface modified lithium-containing composite oxide was prepared in the same manner as in Example 1 except that to 200 g of the powder of the lithium-containing composite oxide, an aqueous solution having a pH of 4.0 and having 20.37 g of a titanium lactate aqueous solution having a Ti content of 8.20% by weight, 0.39 g of lithium carbonate having a lithium content of 18.7% by weight and 7.18 g of lanthanum acetate dissolved in 42.06 g of water was used as the coating solution, in a coating amount based on a base material of 1.7 mol % as calculated as titanium. Of the surface modified lithium-containing composite oxide, the average particle size D50 was 15.7 μm, D10 was 8.4 μm, D90 was 27.4 μm, and the specific surface area as obtained by the BET method was 0.40 m²/g. The alkali amount of the powder of the surface modified lithium-containing composite oxide was 0.006% by weight.

With respect to the powder of the surface modified lithium-containing composite oxide, an X-ray diffraction spectrum was measured in the same manner as in Example 1, whereupon peaks derived from a lithium-containing composite oxide and a highly crystalline lithium lanthanoid titanium composite oxide having a perovskite crystal structure were confirmed. Further, the half value width of the diffraction peak of (110) plane at 2θ=66.5±1° was 0.105°. The press density of the powder was 2.92 g/cm³.

With respect to the above surface modified lithium-containing composite oxide, electrodes and batteries were prepared and evaluated in the same manner as in Example 1. As a result, the 4.3 V initial discharge capacity was 149 mAh/g, the high rate capacity retention was 93.3%, and the high rate average electric potential was 3.86 V.

Further, the 4.5 V initial discharge capacity was 180 mAh/g, the 4.5 V initial charge and discharge efficiency was 93.5%, the 4.5 V initial average electric potential was 4.02 V, the 4.5 V capacity retention was 93.9%, and the 4.5 V average electric potential was 3.97 V. Further, the heat generation starting temperature was 162° C.

### Example 6

A surface modified lithium-containing composite oxide was prepared in the same manner as in Example 1 except that as the coating solution, an aqueous solution having a pH of 4.1 and having 11.98 g of a titanium lactate aqueous solution having a Ti content of 8.20% by weight, 0.38 g of lithium carbonate having a lithium content of 18.7% by weight and 2.82 g of lanthanum acetate dissolved in 54.82 g of water was used. Of the surface modified lithium-containing composite oxide, the average particle size D50 was 14.1 μm, D10 was 8.5 μm, D90 was 22.0 μm, and the specific surface area as obtained by the BET method was 0.32 m²/g. The alkali amount of the powder of the surface modified lithium-containing composite oxide was 0.006% by weight.

Further, an X-ray diffraction spectrum of the obtained surface modified lithium-containing composite oxide was measured by using RINT 2100 model manufactured by RIGAKU Corporation. In a spectrum chart obtained by this measurement, peaks derived from a lithium-containing composite oxide and a highly crystalline lithium lanthanoid titanium composite oxide having a perovskite crystal structure were confirmed. Further, the half value width of the diffraction peak of (110) plane at 2θ=66.5±1° was 0.107°. The press density of the powder was 2.93 g/cm³.

With respect to the above surface modified lithium-containing composite oxide, electrodes and batteries were prepared and evaluated in the same manner as in Example 1. As a result, the 4.3 V initial discharge capacity was 153 mAh/g, the high rate capacity retention was 94.2%, and the high rate average electric potential was 3.86 V.

Further, the 4.5 V initial discharge capacity was 184 mAh/g, the 4.5 V initial charge and discharge efficiency was 92.9%, the 4.5 V initial average electric potential was 4.03 V, the 4.5 V capacity retention was 86.6%, and the 4.5 V average electric potential was 3.89 V. Further, the heat generation starting temperature was 166° C.

### Example 7

A surface modified lithium-containing composite oxide was prepared in the same manner as in Example 1 except that as the coating solution, an aqueous solution having a pH of 3.9 and having 11.98 g of a titanium lactate aqueous solution having a Ti content of 8.20% by weight and 6.34 g of lanthanum acetate dissolved in 51.68 g of water was used. Of the surface modified lithium-containing composite oxide, the average particle size D50 was 15.5 μm, D10 was 8.8 μm, D90 was 24.9 μm, and the specific surface area as obtained by the BET method was 0.37 m²/g. The alkali amount of the powder of the surface modified lithium-containing composite oxide was 0.006% by weight.

Further, an X-ray diffraction spectrum of the obtained surface modified lithium-containing composite oxide was measured by using RINT 2100 model manufactured by RIGAKU Corporation. In a spectrum chart obtained by this measurement, peaks derived from a lithium-containing composite oxide and a highly crystalline lithium lanthanoid titanium composite oxide having a perovskite crystal structure were confirmed. Further, the half value width of the diffraction peak of (110) plane at 2θ=66.5±1° was 0.108°. The press density of the powder was 2.90 g/cm³.

With respect to the above surface modified lithium-containing composite oxide, electrodes and batteries were prepared and evaluated in the same manner as in Example 1. As a result, the 4.3 V initial discharge capacity was 150 mAh/g, the high rate capacity retention was 93.3%, and the high rate average electric potential was 3.87 V.

Further, the 4.5 V initial discharge capacity was 180 mAh/g, the 4.5 V initial charge and discharge efficiency was 91.6%, the 4.5 V initial average electric potential was 4.04 V, the 4.5 V capacity retention was 89.3%, and the 4.5 V average electric potential was 3.92 V. Further, the heat generation starting temperature was 162° C.

### Example 8

A surface modified lithium-containing composite oxide was prepared in the same manner as in Example 3 except that as the coating solution, an aqueous solution having a pH of 4.1 and having 11.98 g of a titanium lactate aqueous solution having a

Ti content of 8.20% by weight, 0.38 g of lithium carbonate having a lithium content of 18.7% by weight and 2.82 g of lanthanum acetate dissolved in 54.82 g of water was used. Of the surface modified lithium-containing composite oxide, the average particle size D50 was 15.1 μm, D10 was 8.6 μm, D90 was 23.9 μm, and the specific surface area as obtained by the BET method was 0.26 m²/g. The alkali amount of the surface modified lithium-containing composite oxide was 0.004% by weight.

Further, an X-ray diffraction spectrum of the obtained surface modified lithium-containing composite oxide was measured by using RINT 2100 model manufactured by RIGAKU Corporation. In a spectrum chart obtained by this measurement, peaks derived from a lithium-containing composite oxide and a highly crystalline lithium lanthanoid titanium composite oxide having a perovskite crystal structure were confirmed. Further, the half value width of the diffraction peak of (110) plane at 2θ=66.5±1° was 0.103°. The press density of the powder was 2.97 g/cm³.

With respect to the above surface modified lithium-containing composite oxide, electrodes and batteries were prepared and evaluated in the same manner as in Example 1. As a result, the 4.3 V initial discharge capacity was 150 mAh/g, the high rate capacity retention was 93.6%, and the high rate average electric potential was 3.89 V.

Further, the 4.5 V initial discharge capacity was 181 mAh/g, the 4.5 V initial charge and discharge efficiency was 93.0%, the 4.5 V initial average electric potential was 4.04 V, the 4.5 V capacity retention was 94.8%, and the 4.5 V average electric potential was 3.97 V. Further, the heat generation starting temperature was 166° C.

### Example 9

To 14,000 g of the same lithium-containing composite oxide having a composition of Li_{1.01}(Co_{0.979}Mg_{0.01}Al_{0.01}Zr_{0.001})_{0.99}O₂ as in Example 1 prepared in a large amount, an aqueous solution having a pH of 4.0 and having 83.89 g of a titanium lactated aqueous solution having a Ti content of 8.20% by weight, 1.60 g of lithium carbonate having a lithium content of 18.7% by weight and 29.57 g of lanthanum acetate dissolved in 2,684.94 g of water as a coating solution was sprayed in a coating amount based on a base material of 0.1 mol % as calculated as titanium and heat was applied while the lithium-containing composite oxide was stirred by using a lodige mixer to obtain lithium lanthanoid titanium-impregnated particles. The obtained lithium lanthanoid titanium-impregnated particles were subjected to heat treatment in an oxygen-containing atmosphere at 700° C. for 12 hours and then crushed to obtain a powder of a surface-modified lithium-containing composite oxide having an average particle size D50 of 12.5 μm, D10 of 8.1 μm, D90 of 18.7 μm and a specific surface area as obtained by the BET method of 0.24 m²/g. The alkali amount of the obtained powder of the surface modified lithium-containing composite oxide was 0.009% by weight.

With respect to the powder of the surface modified lithium-containing composite oxide, an X-ray diffraction spectrum was measured in the same manner as in Example 1, whereupon the half value width of the diffraction peak of (110) plane at 2θ6=66.5±1° was 0.100°. The press density of the powder was 2.93 g/cm³. Further, in FIG. 2 illustrating an X-ray diffraction spectrum of a powder obtained by subjecting the coating solution to heat treatment at 700° C., peaks derived from Li_{0.35}La_{0.55}TiO₃ having a perovskite crystal structure are confirmed. Further, in Example 1 wherein the coating amount was 1 mol % as calculated as titanium, a highly crystalline lithium lanthanoid titanium composite oxide was confirmed. Accordingly, it is judged that in the surface layer of the obtained surface modified lithium-containing composite oxide, a highly crystalline lithium lanthanoid titanium composite oxide having a perovskite crystal structure is contained in the same manner.

With respect to the above surface modified lithium-containing composite oxide, electrodes and batteries were prepared and evaluated in the same manner as in Example 1. As a result, the 4.3 V initial discharge capacity was 152 mAh/g, the high rate capacity retention was 93.8%, and the high rate average electric potential was 3.90 V.

Further, the 4.5 V initial discharge capacity was 180 mAh/g, the 4.5 V initial charge and discharge efficiency was 92.0%, the 4.5 V initial average electric potential was 4.02 V, the 4.5 V capacity retention was 95.2%, and the 4.5 V average electric potential was 3.98 V. Further, the heat generation starting temperature was 165° C.

### Comparative Example 1

A powder of a lithium-containing composite oxide having a composition of Li_{1.01}(Co_{0.979}M_{0.01}Al_{0.01}Zr_{0.001})_{0.99}O₂ as a base material prepared in Example 1 was evaluated. As a result, the average particle size D50 was 12.0 μm, D10 was 6.8 μm, D90 was 18.1 μm, the specific area as obtained by the BET method was 0.28 m²/g, and the alkali amount was 0.014% by weight.

With respect to the powder of the lithium-containing composite oxide, an X-ray diffraction spectrum was measured in the same manner as in Example 1, whereupon only peaks derived from a lithium-containing composite oxide were observed. The half value width of the diffraction peak of (110) plane at 2θ=66.5±1° was 0.114°. The press density of the powder was 3.06 g/cm³.

With respect to the above lithium-containing composite oxide, electrodes and batteries were prepared and evaluated in the same manner as in Example 1. As a result, the 4.3 V initial discharge capacity was 155 mAh/g, the high rate capacity retention was 92.5%, and the high rate average electric potential was 3.87 V.

Further, the 4.5 V initial discharge capacity was 180 mAh/g, the 4.5 V initial charge and discharge efficiency was 91.4%, the 4.5 V initial average electric potential was 4.02 V, the 4.5 V capacity retention was 60.0%, and the 4.5 V average electric potential was 3.84 V. Further, the heat generation starting temperature was 155° C.

Comparative Example 2

A surface modified lithium-containing composite oxide was prepared in the same manner as in Example 1 except that as the coating solution, an aqueous solution containing no lanthanoid source, having a pH of 2.3 and having 11.98 g of a titanium lactate aqueous solution having a Ti content of 8.20% by weight and 0.23 g of lithium carbonate having a lithium content of 18.7% by weight dissolved in 57.79 g of water, was used. Of the surface modified lithium-containing composite oxide, the average particle size D50 was 13.8 μm, D10 was 8.6 μm, D90 was 21.3 μm, and the specific surface area as obtained by the BET method was 0.27 m²/g. Further, the alkali amount of the obtained powder of the surface modified lithium titanium composite oxide was 0.014% by weight.

With respect to the powder of the surface modified lithium-containing composite oxide, an X-ray diffraction spectrum was measured in the same manner as in Example 1, whereupon peaks derived from a lithium-containing composite oxide and LiTiO₂ were confirmed. Further, the half value width of the diffraction peak of (110) plane at 2θ=66.5±1° was 0.103°. The press density of the powder was 2.92 g/cm³.

With respect to the above surface modified lithium-containing composite oxide, electrodes and batteries were prepared and evaluated in the same manner as in Example 1. As a result, the 4.3 V initial discharge capacity was 152 mAh/g, the high rate capacity retention was 93.5%, and the high rate average electric potential was 3.83 V.

Further, the 4.5 V initial discharge capacity was 183 mAh/g, the 4.5 V initial charge and discharge efficiency was 93.5%, the 4.5 V initial average electric potential was 4.02 V, the 4.5 V capacity retention was 88.9%, and the 4.5 V average electric potential was 3.93 V. Further, the heat generation starting temperature was 157° C.

### Comparative Example 3

A surface modified lithium-containing composite oxide was prepared in the same manner as in Example 1 except that to 200 g of the powder of the lithium-containing composite oxide, an aqueous solution having a pH of 4.0 and having 29.96 g of a titanium lactate aqueous solution having a Ti content of 8.20% by weight, 0.57 g of lithium carbonate having a lithium content of 18.7% by weight and 10.56 g of lanthanum acetate dissolved in 28.91 g of water was used as the coating solution in a coating amount of 3.0 mol % based on a base material. Of the surface modified lithium-containing composite oxide, the average particle size D50 was 20.1 μm, D10 was 9.0 μm, D90 was 55.2 μm, and the specific surface area as obtained by the BET method was 0.60 m²/g. The alkali amount of the powder of the surface modified lithium-containing composite oxide was 0.009% by weight.

With respect to the powder of the surface modified lithium-containing composite oxide, an X-ray diffraction spectrum was measured in the same manner as in Example 1, whereupon peaks attributable to a perovskite crystal structure were confirmed in addition to peaks of LiCoO₂. Further, the half value width of the diffraction peak of (110) plane at 2θ=66.5±1° was 0.131°. The press density of the powder was 2.82 g/cm³.

With respect to the above surface modified lithium-containing composite oxide, electrodes and batteries were prepared and evaluated in the same manner as in Example 1. As a result, the 4.3 V initial discharge capacity was 147 mAh/g, the high rate capacity retention was 90.8%, and the high rate average electric potential was 3.84 V.

Further, the 4.5 V initial discharge capacity was 178 mAh/g, the 4.5 V initial charge and discharge efficiency was 92.7%, the 4.5 V initial average electric potential was 4.02 V, the 4.5 V capacity retention was 84.3%, and the 4.5 V average electric potential was 3.91 V. Further, the heat generation starting temperature was 161° C.

### Comparative Example 4

A surface modified lithium-containing composite oxide was prepared in the same manner as in Example 1 except that the heat treatment temperature for the lithium lanthanoid titanium-impregnated particles was changed from 700° C. to 400° C. Of the surface modified lithium-containing composite oxide, the average particles size D50 was 18.6 μm, D10 was 10.3 μm, D90 was 31.6 μm, and the specific surface area as obtained by the BET method was 0.90 m²/g. Further, of the obtained powder of the surface modified lithium-containing composite oxide, the alkali amount was 0.013% by weight, and the press density was 2.81 g/cm³.

With respect to the powder of the surface modified lithium lanthanoid titanium composite oxide, an X-ray diffraction spectrum was measured in the same manner as in Example 1, whereupon no diffraction peak at 2θ=32.0±1.0° was confirmed, and the lithium lanthanoid titanium composite oxide was substantially amorphous.

With respect to the above surface modified lithium-containing composite oxide, electrodes and batteries were prepared and evaluated in the same manner as in Example 1. As a result, the 4.3 V initial discharge capacity was 149 mAh/g, the high rate capacity retention was 92.3%, and the high rate average electric potential was 3.82 V.

Further, the 4.5 V initial discharge capacity was 176 mAh/g, the 4.5 V initial charge and discharge efficiency was 90.8%, the 4.5 V initial average electric potential was 4.01 V, the 4.5 V capacity retention was 70.7%, and the 4.5 V average electric potential was 3.77 V. Further, the heat generation starting temperature was 159° C.

### Comparative Example 5

To 200 g of a lithium-containing composite oxide having a composition of Li_{1.01}(Co_{0.979}Mg_{0.01}Al_{0.01}Zr_{0.001})_{0.99}O₂ obtained in the same manner as in Example 1, a coating solution having 11.98 g of a titanium lactate aqueous solution having a Ti content of 8.20% by weight, 0.57 g of lithium nitrate having a lithium content of 18.7% by weight, 5.33 g of lanthanum acetate and 0.16 g of ammonium fluoride dissolved in 52.12 g of water was added and mixed, and the mixture was dried at 120° C. for 4 hours with stirring to obtain lithium lanthanoid titanium-impregnated particles containing fluorine. Then, the impregnated particles were subjected to heat treatment in an oxygen-containing atmosphere at 400° C. for 12 hours and crushed to obtain a powder of a surface modified lithium-containing composite oxide containing fluorine, having an average particle size D50 of 16.3 μm, D10 of 9.4 μm, D90 of 26.1 μm, and a specific surface area as obtained by the BET method of 0.50 m²/g. The press density of the powder was 2.81 g/cm³. The alkali amount of the obtained surface modified lithium-containing composite oxide containing fluorine (hereinafter referred to as F-containing surface modified lithium-containing composite oxide) was 0.009% by weight. With respect to the powder of the F-containing surface modified lithium-containing composite oxide, an X-ray diffraction spectrum was measured in the same manner as in Example 1, whereupon no diffraction peak was confirmed at 2θ=32.0±1.0°, and the lithium lanthanoid titanium composite oxide containing fluorine was found to be substantially amorphous.

With respect to the above F-containing surface modified lithium-containing composite oxide, electrodes and batteries were prepared and evaluated in the same manner as in Example 1. As a result, the 4.3 V initial discharge capacity was 144 mAh/g, the high rate capacity retention was 87.0%, and the high rate average electric potential was 3.67 V.

Further, the 4.5 V initial discharge capacity was 174 mAh/g, the 4.5 V initial charge and discharge efficiency was 88.8%, the 4.5 V initial average electric potential was 3.92 V, the 4.5 V capacity retention was 47.9%, and the 4.5 V average electric potential was 3.36 V. Further, the heat generation starting temperature was 168° C.

### INDUSTRIAL APPLICABILITY

A surface modified lithium-containing composite oxide having large discharge capacity and volume capacity density, high safety, an excellent rate property and excellent durability for charge and discharge cycles, obtained by the present invention, is widely useful as a cathode active material for a positive electrode for a lithium ion secondary battery.

The entire disclosure of Japanese Patent Application No. 2008-167938 filed on Jun. 26, 2008 including specification, claims, drawings and summary is incorporated herein by reference in its entirety.

What is claimed is:

1. A process for producing particles of a surface modified lithium-containing composite oxide comprising particles of a lithium-containing composite oxide represented by the formula: LiₚNₓM_{y}O_{z}Fₐ, wherein N is at least one element selected from the group consisting of Co, Mn and Ni, M is at least one element selected from the group consisting of Al, Sn, alkaline earth metal elements and transition metal elements other than Co, Mn and Ni,0.9≦p<1.3, 0.9≦x≦2.0, 0≦y≦0.1, 1.9≦z≦4.2, and 0≦a≦0.05, and a highly crystalline lithium lanthanoid titanium composite oxide having a perovskite structure containing no fluorine contained in the surface layer of the particles, which comprises impregnating the particles of the lithium-containing composite oxide with a solution containing a lanthanoid source and a titanium source, and subjecting the obtained impregnated particles to heat treatment at from 550 to 1,000° C.

2. The process according to claim 1, wherein the solution containing a lanthanoid source and a titanium source has a pH of from 1 to 7.

3. The process according to claim 1, wherein the solution containing a lanthanoid source and a titanium source contains a carboxylic acid having at least 2 carboxyl groups, or at least 2 in total of carboxyl groups and hydroxyl groups or carbonyl groups.

4. The process according to claim 1, wherein the titanium source is titanium lactate.

5. The process according to claim 1, wherein the solution containing a lanthanoid source and a titanium source is an aqueous solution.

6. The process according to claim 1, wherein the heat treatment temperature is from 650 to 900° C.

7. The process according to claim 1, wherein the solution containing a lanthanoid source and a titanium source contains a lithium source.

8. The process according to claim 7, wherein the lithium source is lithium carbonate.

9. The process according to claim 1, wherein the lanthanoid source is at least one lanthanum compound selected from the group consisting of lanthanum acetate, lanthanum carbonate and lanthanum oxide.

10. The process according to claim 1, wherein when the particles of the lithium-containing composite oxide are impregnated with the solution containing a lanthanoid source and a titanium source, the solution is sprayed while the lithium-containing composite oxide is stirred.

11. A surface modified lithium-containing composite oxide, comprising particles of a lithium-containing composite oxide represented by the formula: LiₚNₓM_{y}O_{z}Fₐ, wherein N is at least one element selected from the group consisting of Co, Mn and Ni, M is at least one element selected from the group consisting of Al, Sn, alkaline earth metal elements and transition metal elements other than Co, Mn and Ni, 0.9≦p≦1.3, 0.9≦x≦2.0, 0≦y≦0.1, 1.9≦z≦4.2, and 0≦a≦0.05, and a highly crystalline lithium lanthanoid titanium composite oxide having a perovskite structure containing no fluorine contained in the surface layer of the particles.

12. The surface modified lithium-containing composite oxide according to claim 11, wherein the lithium lanthanoid titanium composite oxide is contained in a ratio of from 0.01 to 2 mol % as calculated as titanium based on the lithium-containing composite oxide.

13. The surface modified lithium-containing composite oxide according to claim 11, wherein in an X-ray diffraction spectrum in which CuKa rays are used, a diffraction peak at 2θ=32.0±1.0° is shown, and the half value width of the diffraction peak is from 0.1 to 1.3°.

14. The surface modified lithium-containing composite oxide according to claim 11, wherein the lithium lanthanoid titanium composite oxide is a compound represented by the formula Li_{q}LnᵣTiO₃, wherein Ln is at least one element selected from the group consisting of La, Pr, Nd and Sm, 0≦q≦0.5, 0.1≦r≦1, and 0.4≦q+r≦1.

15. The surface modified lithium-containing composite oxide according to claim 14, wherein 0.01≦q≦0.5, and 0.1≦r≦0.95.

16. The surface modified lithium-containing composite oxide according to claim 11, wherein the M element contains at least one element selected from the group consistng of Al, Ti, Zr, Hf, Nb, Ta, Mg, Sn and Zn.

17. A positive electrode for a lithium secondary battery, which comprises a cathode active material, an electroconductive material and a binder, wherein the cathode active material is the surface modified lithium-containing composite oxide as defined in claim 11.

18. A lithium ion secondary battery, which comprises a positive electrode, a negative electrode, an electrolytic solution and an electrolyte, wherein the positive electrode is the positive electrode as defined in claim 17.
